(19) United States
(12) Patent Application Publication
(10) Pub. No.: US 2005/0030582 A1
(43) Pub. Date: Feb. 10, 2005

(54) Multi-function printer system, a multi-function printer, a server, and a method and program for reducing a environmental load

(76) Inventor: Yu Xu, Ohta-ku (JP)

Correspondence Address: MORRISON & FOERSTER LLP, 1650 TYSONS BOULEVARD, SUITE 300, MCLEAN, VA, 22102, US

(21) Appl. No.: 10/902,484

(22) Filed: Jul. 30, 2004

(30) Foreign Application Priority Data
Aug. 5, 2003 (JP) 2003-287217

(51) Int. Cl. G06F 15/00

(52) U.S. Cl. 358/1.15

(57) ABSTRACT

A multi-function printer reduces a work load to a user by causing a multi-function printer to link with a server. The multi-function printer is equipped with a server and at least one client terminal is connected to the multi-function printer through a communication network. An energy-saving operation of the multi-function printer and an energy-saving operation of the server are set so that they relate to each other. The energy-saving operation of the multi-function printer is performed in accordance with the setting, and the energy-saving operation of the server is performed in linkage with the energy-saving operation of the multi-function printer.

### BACKGROUND OF THE INVENTION

1. Field of the Invention

The present invention generally relates to multi-function printers and, more particularly, to a multi-function printer and system which can reduce an environmental load in use and also reduce a work load to a user.

2. Description of the Related Art

Many image forming apparatuses such as a printer or a copy machine are used in work and operations in an office or the like. In recent years, a multi-function printer (MFP) is widely used, which alone provides a printer function, a copy function, a facsimile function, a scanner function, etc.

Meanwhile, it has become an important issue to reduce an environmental load in business activity due to an increase in consideration of an environmental problems and its importance in recent years. According to such a background, an motion to evaluate enterprises from a viewpoint of an environmental management represented by, for example, ISO14000 series, has become active. For example, a manufacture is required to make efforts to produce a product with a lower environmental load.

One of important items in such evaluation is Life Cycle Assessment (LCA). In LCA, an environmental load during a period from a manufacturing stage to a waste disposal stage (more specifically, the stages of row material acquisition, material production, parts manufacturing, product manufacturing, sales, transportation, use, disposal, and recycle.) is calculated in quantification. Here, it is also important to evaluate environmental influence in the stage of use of manufacture.

Therefore, also a large-scale office-machine such as the MFP is designed to achieve a lower power consumption (energy saving) by controlling power consumption especially during a standby time so as to reduce an environmental load in the stage of use (for example, refer to Japanese Laid-Open Patent Application No. 2001-328313). In such an energy-saving operation, usually, an arbitrary time interval and a predetermined energy-saving item are set so that the energy-saving item is executed when non-operation time (no operation or input time period) reaches a setting time. Therefore, a setting corresponding to a use environment of a user can be achieved, which can appropriately reduce an environmental load during use.

On the other hand, the function of MFP has been extended and, for example, a system in which the MFP is connected to a server with a communication network such as a local area network (LAN) has been realized so as to efficiently perform versatile functions by cooperation of the MFP and the server. For example, image data acquired according to scanner function of the MFP or image data received according to a facsimile function is distributed through the server to a designated client terminal that is connected to the server via the LAN.

The server used for such a system is usually used as an exclusive server for supporting the MFP. Accordingly, the server operates always in connection with an operation of the MFP. However, it is needed to install a computer apparatus separate from the MFP, which unnecessarily occupies a space. Additionally, it is inconvenient for a user to perform a maintenance and management work separately from the MFP.

On the other hand, if the server is exclusive for supporting the MFP, the energy-saving setting can be common to each other since the operation time and the standby time of the MFP and the server are substantially the same. However, with respect to the setting of the energy-saving operation, a function to link the MFP with the server has not been realized. That is, it is required to separately perform an energy-saving setting for each of the MFP and the server.

Moreover, in order to effectively reduce an environmental load during use of a product, it is desirable to change an energy-saving in accordance with a use environment. However, if the energy-saving setting must be performed separately on each of the MFP and the server, a work load to a user due to the setting change is large. Further, it is inconvenient since a change in setting through a network cannot be made.

### SUMMARY OF THE INVENTION

It is a general object of the present invention to provide an improved and useful multi-function printer in which the above-mentioned problems are eliminated.

A more specific object of the present invention is to provide a multi-function printer which reduces a work load to a user by causing a multi-function printer to link with a server.

Another object of the present invention is to provide a multi-function printer which reduces an environmental load during use by providing a flexible setting environment.

In order to achieve the above-mentioned objects, there is provided according to one aspect of the present invention a multi-function printer system comprising at least one multi-function printer equipped with a server and at least one client terminal connected with each other through a communication network, the multi-function printer system comprising: means for setting energy-saving operations of the multi-function printer and the server; means for relating the energy-saving operation of the multi-function printer and the energy-saving operation of the server to each other; means for performing the energy-saving operation of the multi-function printer in accordance with the setting; and means for performing the energy-saving operation of the server in linkage with the energy-saving operation of the multi-function printer.

According to the present invention, the energy-saving operation of the multi-function printer and the energy-saving operation of the server that is mounted to the multi-function printer can be liked with each other, thereby effectively reducing an environmental load during use. Additionally, the setting of the energy-saving operations can be performed from the client terminal through the network such as a local area network, thereby reducing a work load to a user when the user performs the setting operation.

The multi-function printer system according to the present invention may further comprise: means for performing the energy-saving operation of the server in accordance with the setting; and means for performing the energy-saving operation of the multi-function printer in linkage with the energy-saving operation performed.

Additionally, in the multi-function printer system according to the present invention, the means for setting the energy-saving operations may set the energy-saving through the communication network in accordance with an input from the client terminal. In the multi-function printer system according to the present invention, the means for setting the energy-saving operations may perform an encryption when performing communication with the client terminal. Additionally, in the multi-function printer system according to the present invention, the means for setting the energy-saving operations may perform an authentication on the client terminal and performs the setting in accordance with an input from the client terminal.

Additionally, there is provided according to another aspect of the present invention a multi-function printer equipped with a server, comprising: an energy-saving operation setting unit that performs setting of an energy-saving operation of the multi-function printer; and an energy-saving operation performing unit that performs the energy-saving operation set by the energy-saving operation setting unit, wherein the energy-saving operation setting unit sets an energy-saving operation of the server that is performed in linkage with the energy-saving operation of the multi-function printer; and the energy-saving operation performing unit cause the server to perform the energy-saving operation of the server in linkage with execution of the energy-saving operation of the multi-function printer. In the above-mentioned multi-function printer, the energy-saving operation setting unit may set the energy-saving operations in accordance with an input received from a client terminal connected through a communication network.

Additionally, there is provided according to another aspect of the present invention a server adapted to be mounted to a multi-function printer, comprising: energy-saving operation setting means for setting an energy-saving operation set to the multi-function printer and setting information of an energy-saving operation of the server by relating to each other; and energy-saving operation performing means for performing the energy-saving operation of the server in linkage with an execution of the energy-saving operation of the multi-function printer. In the above-mentioned server, the energy-saving operation setting means may set the energy-saving operation of the server in accordance with an input from a client terminal connected through a communication network.

Further, there is provided according to another aspect of the present invention an environmental load reducing method of a multi-function printer system in which at least one multi-function printer equipped with a server and at least one client terminal are connected through a communication network, the method comprising the steps of: setting an energy-saving operation performed in the multi-function printer and an energy-saving operation performed in the server from the client terminal through the communication network; and performing the energy-saving operations while the multi-function printer and the server are linked with each other in accordance with the setting, wherein an environmental load during use of the multi-function printer system is reduced by performing the energy-saving operations in linkage with each other.

Further, there is provided according to another aspect of the present invention a program causing a computer to function as a server adapted to be mounted to a multi-function printer, comprising: energy-saving operation setting means for setting an energy-saving operation set to the multi-function printer and setting information of an energy-saving operation of the server by relating to each other; and energy-saving operation performing means for performing the energy-saving operation of the server in linkage with an execution of the energy-saving operation of the multi-function printer. In the above-mentioned program, the energy-saving operation setting means may set the energy-saving operation of the server in accordance with an input from a client terminal connected through a communication network.

Additionally, there is provided according to another aspect of the present invention a program for causing a computer to perform an environmental load reducing method of a multi-function printer system in which at least one multi-function printer equipped with a server and at least one client terminal are connected through a communication network, the method comprising the steps of: setting an energy-saving operation performed in the multi-function printer and an energy-saving operation performed in the server from the client terminal through the communication network; and performing the energy-saving operations while the multi-function printer and the server are linked with each other in accordance with the setting, wherein an environmental load during use of the multi-function printer system is reduced by performing the energy-saving operations in linkage with each other.

Other objects, features and advantages of the present invention will become more apparent form the following detailed description when read in conjunction with the accompanying drawings.

### BRIEF DESCRIPTION OF THE DRAWINGS

FIG. 1 is an illustration showing a multi-function printer (MFP) system according to a first embodiment of the present invention;

FIG. 2 is a block diagram of a multi-function printer (MFP) shown in FIG. 1;

FIG. 3 is a block diagram of a control unit shown in FIG. 2;

FIG. 4A is an illustration of information stored in a ROM shown in FIG. 3;

FIG. 4B is an illustration of information stored in a flash memory shown in FIG. 3;

FIG. 5 is an illustration showing an example of network management data shown in FIG. 4B;

FIG. 6 is an illustration showing an example of energy-saving management data shown in FIG. 4B;

FIG. 7 is a block diagram of a server shown in FIG. 1;

FIG. 8A is an illustration showing an example of information stored in a program storing unit shown in FIG. 7;

FIG. 8B is an illustration showing an example of information stored in a memory unit shown in FIG. 7;

FIG. 9 is an illustration showing an example of energy-saving management data shown in FIG. 8B;

FIG. 10 is a flowchart of an energy-saving storing process 1 according to the first embodiment of the present invention;

FIG. 11A is an illustration showing an outer configuration of an operation panel of the MFP;

FIG. 11B is an illustration showing an example of a display of an energy-saving setting screen;

FIG. 11C is an illustration showing an example of a display of an server linkage setting screen;

FIG. 12 is a flowchart of an energy-saving operation execution process 1 according to the first embodiment of the present invention;

FIG. 13 is an illustration showing an example of energy-saving management data stored in an MFP supporting server according to a second embodiment of the present invention;

FIG. 14 is a flowchart of an energy-saving setting process 2 according to the second embodiment of the present invention;

FIG. 15 is an illustration showing an example of an energy-saving setting screen displayed by the process shown in FIG. 14;

FIG. 16 is a flowchart of an energy-saving operation execution process 2 according to the second embodiment of the present invention;

FIG. 17 is a flowchart of an energy-saving setting process 3 according to a third embodiment of the present invention;

FIG. 18 is an illustration showing an example of network management data stored in the MFP according to the third embodiment of the present invention;

FIG. 19 is a flowchart of an energy-saving setting process 4 according to a fourth embodiment of the present invention;

FIG. 20 is an illustration showing an example of an energy-saving setting screen displayed by the process shown in FIG. 19;

FIG. 21 is a flowchart of a setting change process according to a fifth embodiment of the present invention; and

FIG. 22 is a perspective view of a multi-function printer to which the present invention is applied.

### DETAILED DESCRIPTION OF THE PREFERRED EMBODIMENTS

A description will now be given, with reference to the drawings, of preferred embodiments of the present invention.

(First Embodiment)

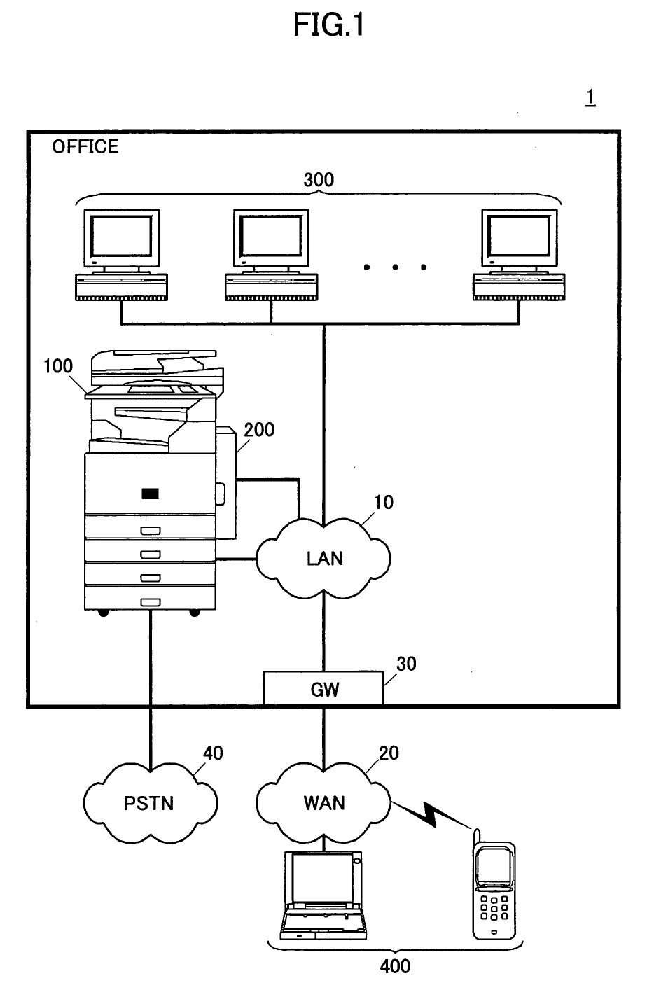

FIG. 1 is an illustration showing a structure of a multi-function printer system according to a first embodiment of the present invention. In the present embodiment, a multi-function printer system 1 (hereinafter referred to as MFP system) is explained as it is used for document processing in operations in business unit such as a company.

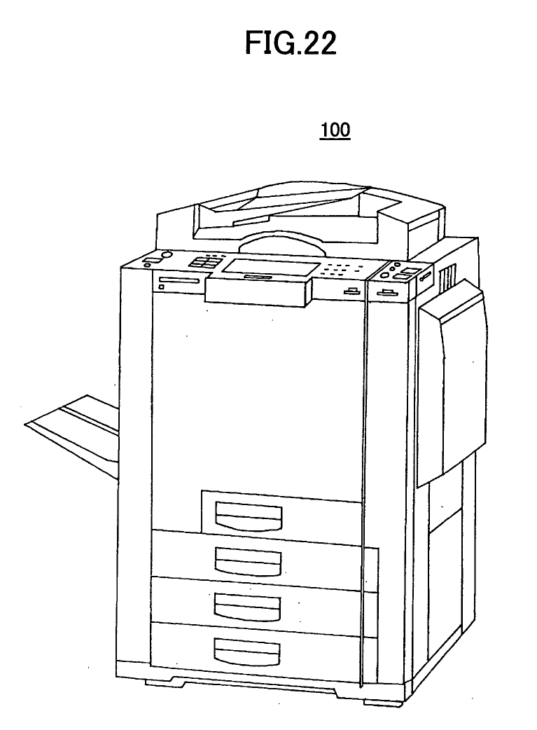

As shown in FIG. 1, the MFP system 1 according to the present embodiment comprises a multi-function printer (MFP) 100, a server 200, an internal client terminal 300 and an external client terminal 400. Among these, the MFP 100, the server 200 and the internal client terminal 300 are installed an office of a business unit, and are mutually connected through a local area network (LAN) 10. One example of the multi-function printer 100 is shown in FIG. 22.

The LAN 10 is connected to a wide area network (WAN) 20 through a predetermined gateway apparatus (GW) 30. The external client terminal 400 is connected to the LAN 10 through the WAN 20 and the gateway apparatus 30. Additionally, the MFP 100 is connected to a public service telephone network (PSTN) 40.

The LAN 10 is a communication network according to a predetermined communications protocol (for example, TCP/IP (Transmission Control Protocol/Internet Protocol)) such as, for example, a cabled LAN such as IEEE802.3 or a wireless LAN such as IEEE802.11b, etc.

The WAN 20 is a communication network such as the Internet based on a predetermined communications protocol such as TCP/IP. The gateway unit 30 consists of communication apparatuses such as a router, and connects the LAN 10 to the WAN 20. In the present embodiment, the gateway apparatus 30 is provided with a predetermined access control function such as a firewall function. The PSTN 40 is an analog or digital telephone line network such as an ordinary subscriber's telephone line or an integrated service digital network (ISDN).

The MFP 100 is a printer generally referred to as a multi-function printer, which has at least a printer function, a copy function, a facsimile function and a scanner function. In the present embodiment, the MFP 100 alone can provide the copy function, and beside the MFP 100 is capable of printing data sent from the internal client terminal 300 connected through the LAN 10 according to the printer function and also capable of exchanging facsimile data through the PSTN according to the facsimile function. Moreover, MFP 100 mounts a server 200 mentioned later so as to provide an extended function such as distribution of image data received according to the facsimile function or image data acquired by the scanner function to the internal client terminal 300.

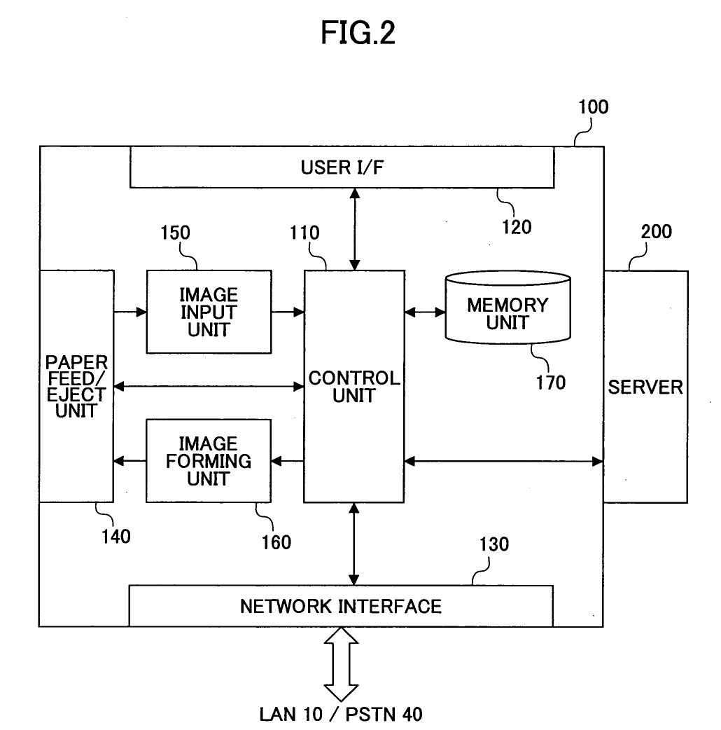

A description will be given below, with reference to FIG>2, of the structure of the MFP 100. FIG. 2 is a block diagram showing the structure of the MFP 100.

As shown in FIG. 2, the MFP 100 comprises a control unit 110, a user interface (I/F) 120, a network interface (I/F) 130, a paper feed/eject unit 140, an image input unit 150, an image forming unit 160, a memory unit 170 and a server 200.

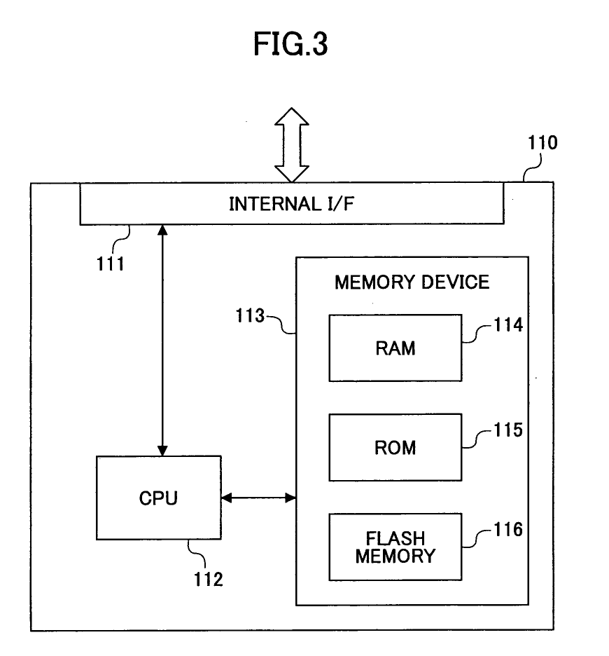

The control unit 110 controls each part of the MFP 100, and has the structure as shown in FIG. 3. As shown in FIG. 3, the control unit comprises an internal interface (I/F) 111, a central processing unit (CPU) 112 and a memory device 113.

The internal interface 111 consists of a predetermined bus interfaces or the like so as to exchange electric signals by connecting the control unit 110 with other components in the MFP 100. The CPU 112 comprises a predetermined arithmetic circuit such as an arithmetic and logic unit (ALU) so as to control each part of the MFP 100 by executing a program stored in the memory device 113. The memory device 113 stores programs and data used and executed by the CPU 112, and comprises a random access memory (RAM) 114, a read only memory (ROM) and a flash memory 116. The RAM 114 consists of a dynamic random access memory (DRAM) or the like, and serves as a main memory and used as a work area of the CPU 112. That is, the programs stored in the ROM 115 and the data stored in the flash memory 116 are loaded to the RAM 114, and are executed by the CPU 112.

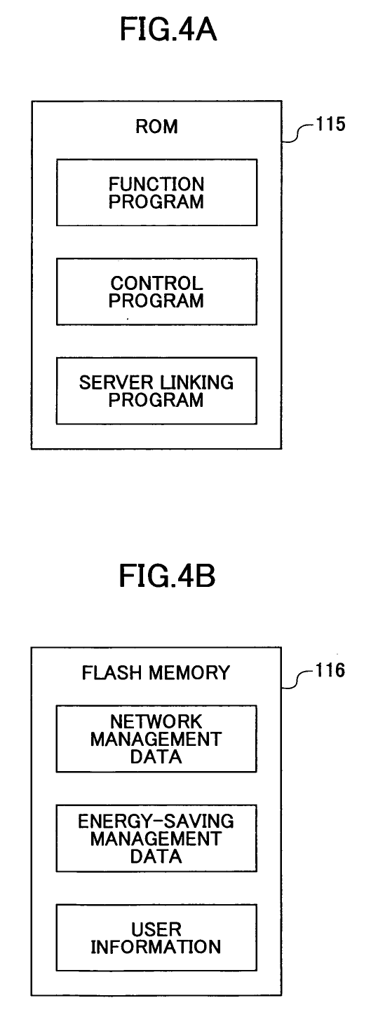

The ROM 115 consists of a mask ROM or an EEPROM (electrically erasable programmable ROM) so as to store the programs which the CPU 112 executes. An example of the program stored in the ROM 115 is shown in FIG. 4A. As shown in FIG. 4, the ROM 115 stores, for example, a function program, a control program, a server linking program. The function program is a program for realizing the function (that is, the copy function, the printer function, the facsimile function and the scanner function) provided by the MFP 100. The control program is a program for controlling an operation of each part (for example, paper feeding/ejecting operation, an image forming operation, an image acquiring operation, etc.) in accordance with the functions executed by the function program. The server linking program is a program for performing an operation in cooperation with the server 200. That is, the server linking program is a program for making synchronization with the server 200 mounted in the apparatus or exchanging necessary data.

The flash memory 116 consists of a rewritable semiconductor memory devices such as a EEPROM or the like so as to store data such as shown in FIG. 4B. That is, the flash memory 116 stores user information, network management data, energy-saving management data, etc. The user information is arbitrarily set up by a user of the MFP 100, and, for example, the user information contains information regarding an address and a user name, etc., used in a facsimile communication.

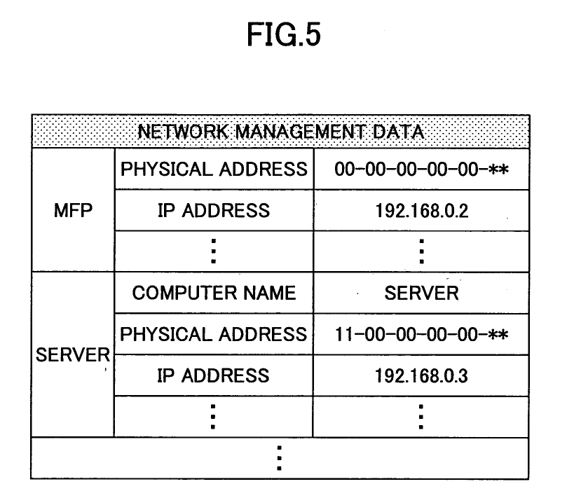

The network management data contains address information required for communication through the LAN 10 as shown in FIG. 5. As shown in FIG. 5, the network management data contains at least address information for discriminating the MEP 100 and the server 200 on the LAN 10. As for the address information, there is used a physical address (media access control (MAC) address) peculiar to a network interface card (NIC) used as an interface with the LAN 10, or an IP address of each node, etc.

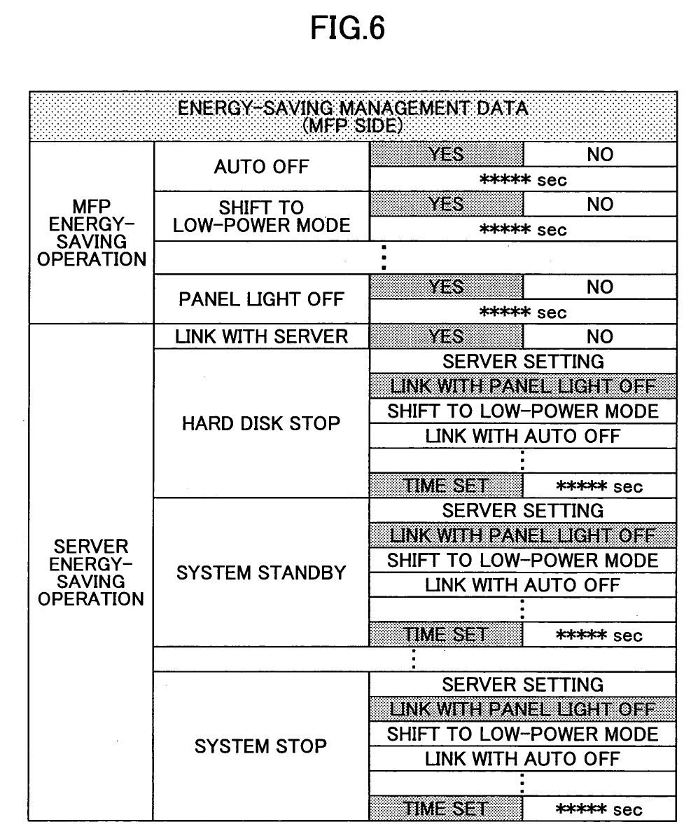

The energy-saving management data is setting information, which specifies an energy-saving operation of the MFP 100 such as shown in FIG. 6. The energy-saving setting item of MFP 100 and the energy-saving setting item of the server 200 are specified in the energy-saving management data, and necessity of execution of an operation concerned and a setting time when executing the operation are recorded. The energy-saving operation of the MFP 100 includes, for example, an automatic off or transition to low-power mode (transition to pre-heating), a panel light off, a system reset, a copy automatic reset, a facsimile automatic reset, a scanner automatic reset, etc. A selection of execution/non-execution (Yes/No) is made for each operation (in the figure, selected items are screened). Moreover, when performing an operation, non-operation time (a time period during which no operation or input is made continuously), which serves as a trigger of starting the execution, is recorded.

Moreover, information (server linkage: Yes/No) indicating whether to cause the energy-saving operation of the MFP 100 to link with the energy-saving operation of the server 200 is recorded. Here, if “Server Linkage: Yes” is indicated, the energy-saving operation of the server 200 mentioned below is performed by being linked with the energy-saving operation performed by the MFP 100. The energy-saving operation of the server 200 includes, for example, operations of a hard disk stop, a system standby, a system pause, etc. The linked energy-saving operation of the MFP 100 is selectively set for each operation item.

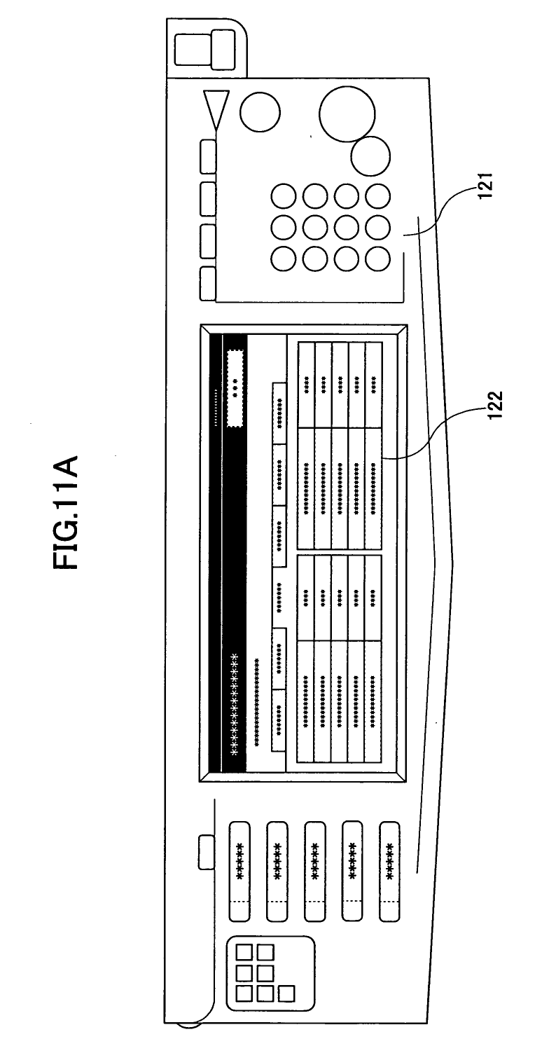

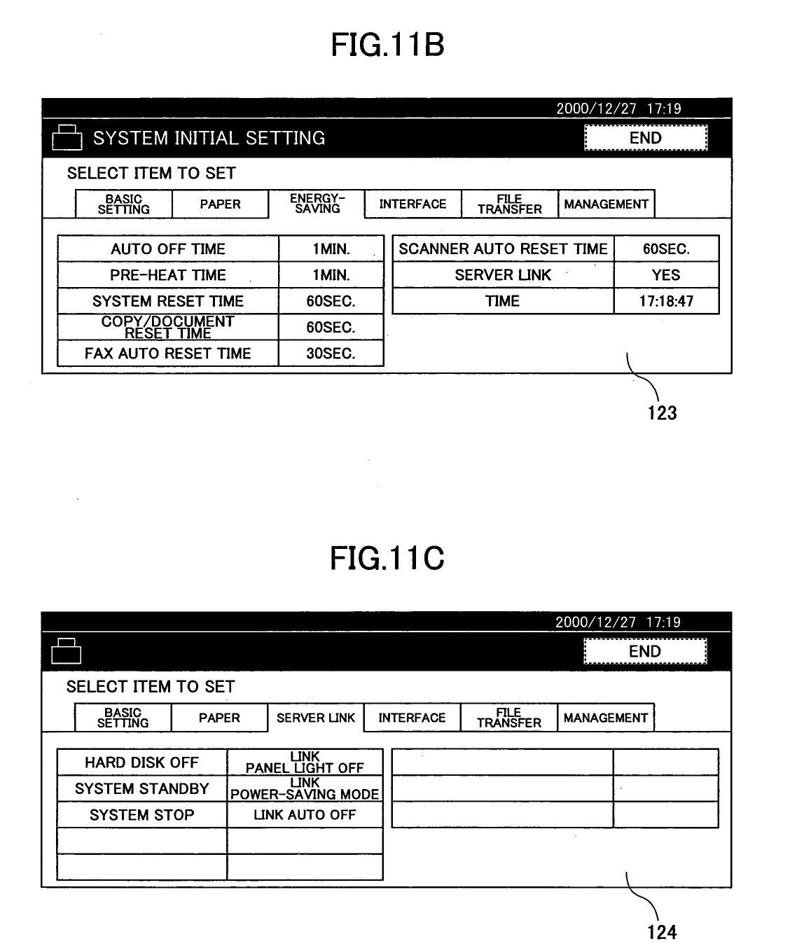

Returning to FIG. 2, a description will be given of other parts of the MFP 100. The user interface 120 comprises an operation panel 121 and a display 122 (refer to FIG. 11) provided on the operation panel 121, and receives input from a user thorough the operation panel 121 and displays predetermined information on the display 122.

The network interface 130 consists of a predetermined NIC or a telephone line connection interfaces, etc., which connect the MFP 100 to the LAN 10 and the PSTN 40 so as to perform communication with each node on the LAN 10 and perform facsimile data transmission and reception. It should be noted that the network interface 130 performs a predetermined encryption such as the secure socket layer (SSL) when performing communication through the LAN 10.

The paper feed/eject unit 140 comprises, for example, an automatic document feeder (ADF), a sorter, a finisher and an internal paper feed mechanism so as to feed and eject an original document, which is supplied according to the copy function, the facsimile function or the scanner function, or an output paper, which is supplied according to the copy function, the facsimile function or the printer function. The image input unit 150 consists of an optical reading apparatus such as a scanner so as to read optically an original document supplied according to the copy function, the facsimile function or the scanner function, and generate image data corresponding to the image of the original document. The image forming unit 160 comprises a printer engine of, for example, a laser type, and perform printing of document data supplied according to the copy function, the printer function and the facsimile function.

The memory unit 170 comprises, for example, a rewritable memory apparatus such as a hard disk apparatus so as to store image data acquired according to the copy function, the facsimile function and scanner function and image data supplied according to the printer function. The server 200 comprises, for example, circuit boards and memory devices that realize a server function, and is integrally mounted on the MFP 100. The server 200 is connected to the MFP 100 through a predetermined interface, so as to expand the function of the MFP 100 in cooperation with the MFP 100.

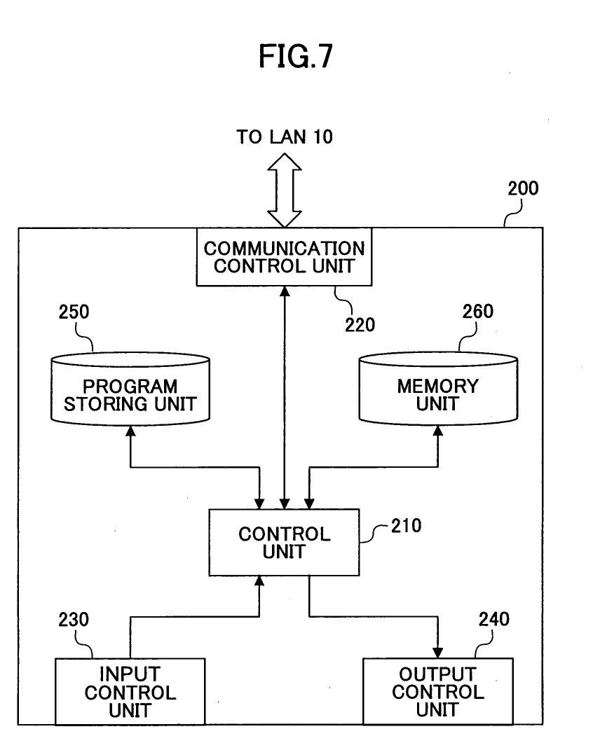

A description will be given, with reference to FIG. 7, of the structure of the server 200. FIG. 7 is a block diagram showing the structure of the server 200.

As shown in FIG. 7, the server 200 comprises a control unit 210, a communication control unit 220, an input control unit 230, an output control unit 240, a program storing unit 250 and a memory unit 260. The control unit 210 comprises, for example, a central processing unit (CPU) and a memory device (random access memory) serving as a work area. The control unit 210 controls each part of the server 200 and performs processes mentioned later in accordance with predetermined programs stored in the program storing unit 250. The communication control unit 220 comprises a predetermined communication apparatus such as a NIC so as to connect the server 200 to the LAN 10 to perform communication with the internal client terminal 300. That is, the server 200 and the MFP 100 are physically constituted to be integral with each other but each has an independent network interface. Thus, the server 200 and the MFP 100 are recognized as separate nodes on the network. It should be noted that the communication control unit 220 performs a predetermined encryption such as the Secure Socket Layer (SSL) or the like when communicating with the internal client terminal 300 through the LAN 10.

The input control section 230 is connected to the user interface 120 of the MFP 100, and transmits information input through the operation panel 121 or the display 122 to the control unit 210. The output control unit 240 is connected to the user interface 120 of the MFP 100, and outputs a result of processing of the control unit 210 to the display 122 if needed. The program storing unit 250 comprises a predetermined memory such as, for example, a hard disk apparatus or a read only memory (ROM) so as to store various programs which the control unit 210 executed.

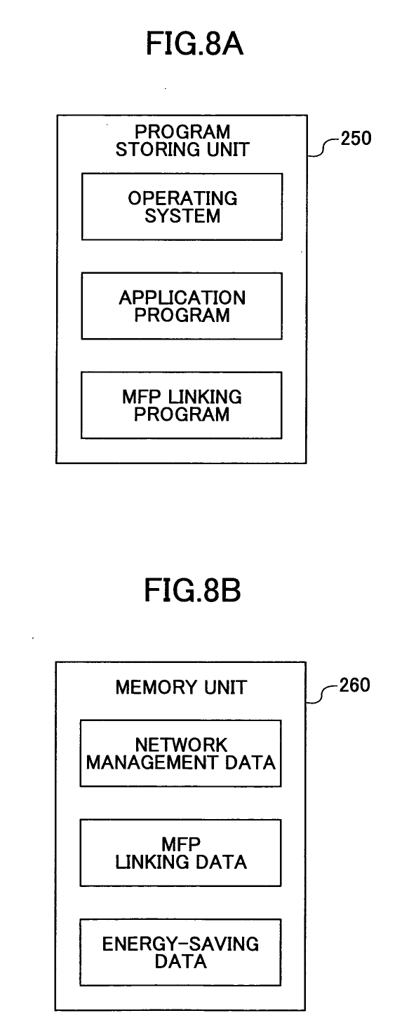

Examples of the programs stored in the program storing unit 250 are shown in FIG. 8A. As shown in FIG. 8A, the program storing unit 250 stores an operating system (OS), an application program, an MFP linking program, etc. Here, the MFP linking program is a program for causing the server 200 to cooperated with the MFP 100, which makes synchronization with the MFP 100 and exchanges necessary data with MFP 100.

Returning to FIG. 7, a description will be given of other parts of the server 200.

The memory unit 260 comprises a rewritable memory device such as a hard disk apparatus or an EEPROM so as to store various sets of data that are used in cooperation with the MFP 100. Examples of the sets of data stored in the memory unit 269 are shown in FIG. 8B. As shown in FIG. 8B, the memory-unit 260 stores network management data, MFP linking data, energy-saving management data, etc. The network management data contains address information for discriminating each node connected to the LAN 10. The MFP linking data is exchanged in cooperation with MFP 100, that is, for example, image data distributed according to a scanner distribution function.

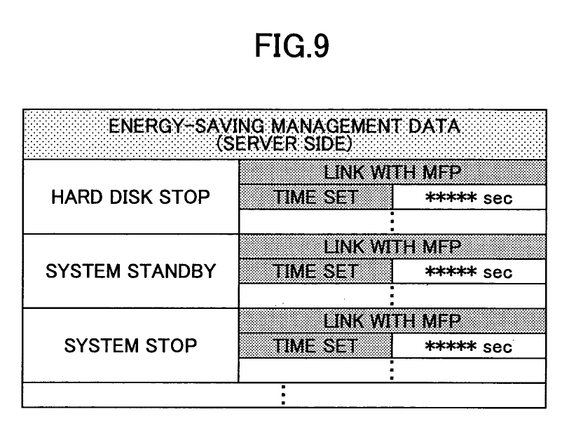

The energy-saving management data is information regarding the energy-saving setting on the server 200, and is information such as shown in FIG. 9. As shown in FIG. 9, the energy-saving management data contains information regarding the energy-saving operation items and information indicating as to whether or not the linkage with the MFP 100 is necessary with respect to each operation item. The energy-saving operation items here are power-saving operations, for example, a hard disk stop operation, a system standby operation or a system stop operation.

Returning to FIG. 1, a description will be given of other parts of the MFP system 1. The internal client terminal 300 comprises an information processing terminal apparatus such as a personal computer (PC), and is installed in an office for business use. The internal client terminal 300 is connected to the LAN 10. That is, the internal client terminal 300 has a structure connectable with the LAN 10 by being provided with a predetermined NIC, thereby connecting the MFP 100 and the server 200 with each other through the LAN 100. The internal client terminal 300 sends predetermined print data to the MFP 100 through the LAN 10, and sends an instruction of printing to the MFP 100. Or, the internal client terminal 300 acquires through the server 200 facsimile image data received according to the facsimile function or image data taken according to the scanner function.

The external client terminal 400 comprises a portable information terminal such as a cellular phone or personal data assistance (PDA) or an information processing terminal apparatus such as a notebook type personal computer, and is used by workers out of the office. The external client terminal 400 has a structure connectable with the LAN 10 through the WAN 20. Namely, for example, the external client terminal 400 is equipped with a communication apparatus connectable with WAN 20 according to a wireless method, thereby connecting to the LAN 10 through the WAN 20. Here, the gateway unit 30 is interposed between the WAN 20 and the LAN 10 so as to perform an access control by performing a predetermined filtering process or the like. For example, the gateway unit 30 performs an access control which causes the external client terminal 400, which is used by the worker of the office, to be connectable with the LAN 100.

A description will now be given of an operation of the MFP system 1 according to the present embodiment. In the present embodiment, the energy-saving setting is performed in the MFP 100, and the energy-saving operations of the MFP 100 and the server 200 is performed according to an instruction of the MFP 100. It should be noted that the control unit 110 of the MFP 100 always executes the server linking program and the control unit 210 of the server 200 always executes the MFP linking program so that the MFP 100 and the server 200 are in synchronization with each other, which achieves a state where bi-directional communication can always be performed.

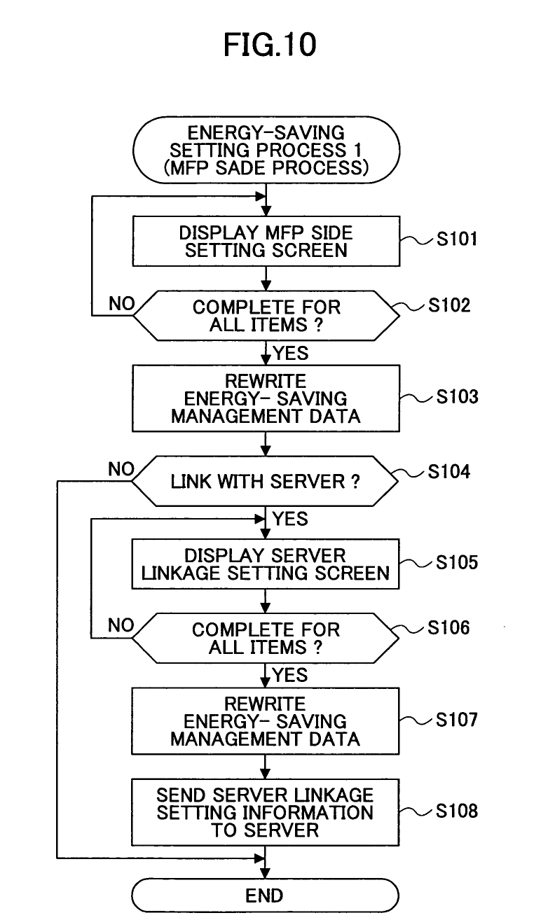

First, a description will be given, with reference to the flowchart of FIG. 10, of an energy-saving setting process 1. The energy-saving setting process 1 is started according to an instruction of a start of an energy-saving setting that is made by a user operating the operation panel 121 of the MFP 100.

In response to the instruction of a start of an energy-saving setting, the control unit 110 of the MFP 100 controls the user interface 120 so as to display an energy-saving screen 123 as shown in FIG. 11B on the display 122 (step S101). Here, the display 122 comprises a touch panel type liquid crystal display device or the like, and a user can perform the setting by directly touching buttons or the like displayed on the display 122. That is, the user inputs through the display 122 information whether to perform each energy-saving operation item as shown in FIG. 6 and a non-operation time if it is performed.

After completion of the setting for all energy-saving operation items on the MFP 100 side according to the selection of an end button on the energy-saving setting screen 123 (step S102: Yes), the control unit 110 rewrites the energy-saving management data in the flash memory 116 to the contents of the setting (step S103). That is, the item corresponding to the MFP energy-saving operation from among pieces of information contained in the energy-saving management data shown in FIG. 6 is updated.

Here, if it is set that the linkage with server should be carried out (step S104: Yes), the control unit 110 displays the server linkage setting screen 124 as shown in FIG. 11C on the display 122 (step S105). On the other hand, if it is set that the linkage with server should not be carried out (step S104: No), the process is ended.

The user operates the display 122 so as to set the energy-saving operation of the server 200 to be linked with one of the energy-saving operation of the MFP 100. For example, when causing the hard disk off operation, which is the energy-saving operation of the server 200, to be linked with the panel light off operation, which is the energy-saving operation of the MFP 100, the “linkage with panel light off” is set to the item of hard disk off displayed on the display 122. When the setting for all items with respect to the server linkage items by selection is completed and the end button on the server linkage setting screen 124 is selected (step S106: Yes), the control unit 110 rewrites the energy-saving management data of the flash memory 116 to the contents of the setting (step S117). That is, the item corresponding to the server energy-saving operation from among pieces of information contained in the energy-saving management data shown in FIG. 6.

The control unit 110 sends the contents of the setting regarding the updated server energy-saving operation to the server 200 through the LAN 10 (step S108), and ends the process. In the server 200, the control unit 210 updates the energy-saving management data of the memory unit 260 in accordance with the received setting information.

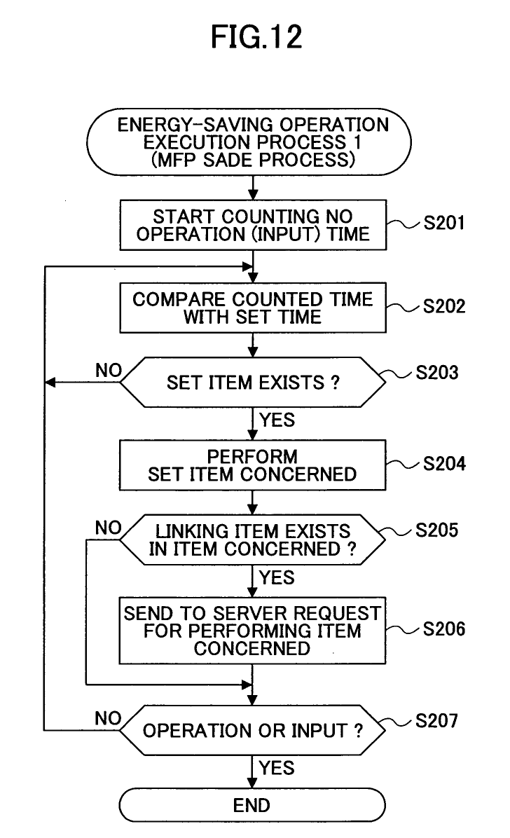

A description will now be given, with reference to the flowchart of FIG. 12, of an energy-saving operation execution process 1 that is set in the above-mentioned condition and performed by the MFP 100. The energy-saving operation execution process 1 is started each time the operation and input with respect to the MFP 100 is completed.

That is, each time the operation to the operation panel 121 or the display 122 or an input operation such as an operation to send printing instruction through the LAN 10 is completed, the control unit 110 of the MFP 100 of the MFP 100 starts counting the time of no operation or no input (step S201). It should be noted that the control unit 110 has a predetermined timer circuit.

The control unit 110 continuously compares the set time of the MFP energy-saving operation defined in the energy-saving management data in the flash memory 116 with a count value of a passed time of the no operation or no input that was started in step S201 (step S202), and determines whether or not there is any item to which the set time equal to the passed time concerned is set (step S203). If there is no item to which a set time equal to the passed time (step S203: No), the control unit 110 continues the count of the no operation or no input time. On the other hand, If there is an item to which a set time equal to the passed time (step S203: Yes), the control unit 110 controls the user interface 120, the network interface 130, the paper feed/eject unit 140, the image input unit 150, the image forming section 160 and the memory unit 170 so as to perform the energy-saving operation corresponding to the item concerned (step S204). For example, if the item is the panel light off operation, the control unit 110 controls the user interface 120 so as to turn off a back light of the display 122. Thus, when a predetermined energy-saving operation is performed as mentioned above, the state of the MFP 100 shifts from an in-operation state to a standby state.

The control unit 110 refers to the energy-saving management data in the flash memory 116 so as to determine whether or not the server energy-saving operation linking with the energy-saving operation performed in step S204 is set (step S205). Here, if there is no linking item (step S205: No), the process of steps S201-S205 is repeated until there are operation or input to the MFP 100 (step S207: No). That is, the count of the no operation or no input time is continued so as to perform the energy-saving operation corresponding to passed time.

On the other hand, if there is an item in which the linking item is set (step S105: Yes), the control unit 110 sends information which requests execution of the energy-saving operation to the server 200 through the LAN 100 (step S206). Here, for example, the information indicating the MFP energy-saving operation performed in step S204 is sent to the server 200. Then, in the server 200, the control unit 210 refers to the energy-saving management data of the memory unit 260 so as to perform the energy-saving operation linking with the MFP energy-saving operation concerned. That is, a predetermined energy-saving operation of the server 200 is performed by linking with the energy-saving operation of the MFP 100. The control unit 110 of the MFP 100 determines whether or not there is an operation or an input to the MFP 100 (step S207). If there is no operation or input (step S207: No), the process of steps S202-S206 is repeated.

On the other hand, when there is an operation or an input to the MFP 100 (step S207: Yes), the process is ended. That is, the MFP 100 returns to a predetermined in-operation state from the standby state.

As mentioned above, according to the operation according to the present embodiment, if an energy-saving operation is set in the MFP 100, a predetermined energy-saving operation is performed in the server 200 in association with the energy-saving operation of the MFP 100 when the energy-saving operation is performed in the MFP 100.

(Second Embodiment)

Although, an energy-saving operation is set in the MFP 100 and the energy-saving operation is performed with linkage with the energy-saving operation of the MFP 100 in the above-mentioned first embodiment, an energy-saving operation of the server 200 may be set first so as to perform the energy-saving operation of the MFP 100 by linking with the energy-saving operation of the server 200. A description will be given below of an operation of the MFP system 1 in such a case. It should be noted that a structure of the MFP system according to the second embodiment is the same as the structure of the MFP system according to the first embodiment.

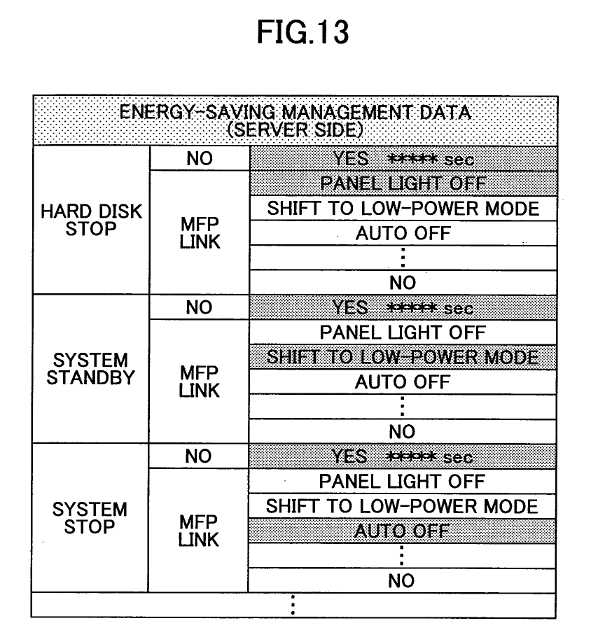

First, in the present embodiment, in order to set up an energy-saving operation item in the server 200, the energy-saving management data stored in the memory unit 260 of the server 200 is different from that in the first embodiment. An example of the energy-saving management data on the server side according to the present embodiment is shown in FIG. 13. As shown in FIG. 13, “energy-saving management data” of the server 200 contains, for each of the energy-saving operation of the server 200, information indicating as to whether the operation is necessary, information regarding a set time when the operation concerned is performed and information regarding the energy-saving operation to be linked with the operation of the MFP 100.

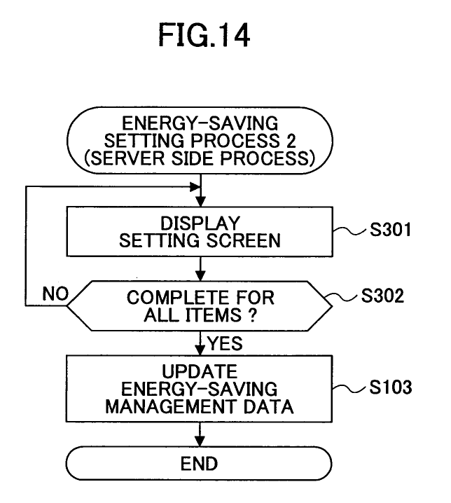

A description will now be given, with reference to a flowchart of FIG. 14, of an energy-saving setting process 2 by the server 200 for setting the energy-saving management data. The energy-saving setting process 2 is started by a user instructing a start of th energy-saving operation of the server 200 by operating the MFP 100.

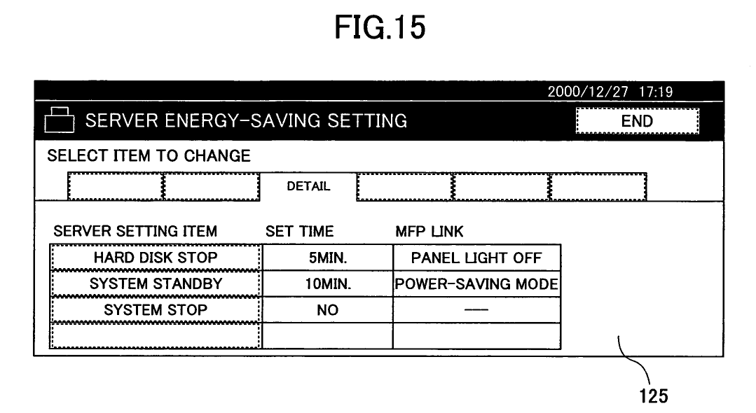

First, the control unit 210 of the server 200 displays a server energy-saving setting screen 125 on the display 122 of MFP 100 first as shown in FIG. 15 (step S301). As shown in FIG. 15, a set time and non-execution with respect to the server side energy operation items are selectively displayed on the server energy-saving setting screen 125. The user selectively inputs, by operating the display 122, the non-execution or a desired set time. Additionally, MFP linking items are displayed for each item on the server energy-saving setting screen 125. Here, the energy-saving operation of the MFP 100 which is to be performed by linking with the set energy-saving operation of the server 200 or non-execution of linkage is displayed.

In FIG. 15, if, for example, the no operation or no input time in the server 200 passed five minutes, the hard disk stop operation is performed, and the panel light off operation of the MFP 100 is performed by liking with the execution of the hard disk stop operation. If an “end” button is selected after each item is set on the energy-saving setting screen 125, the control unit 210 determines that the setting for all items is completed (step S302: Yes), and updates the energy-saving management data of the memory section 260 is updated to the contents of the setting (step S303), and the process is ended.

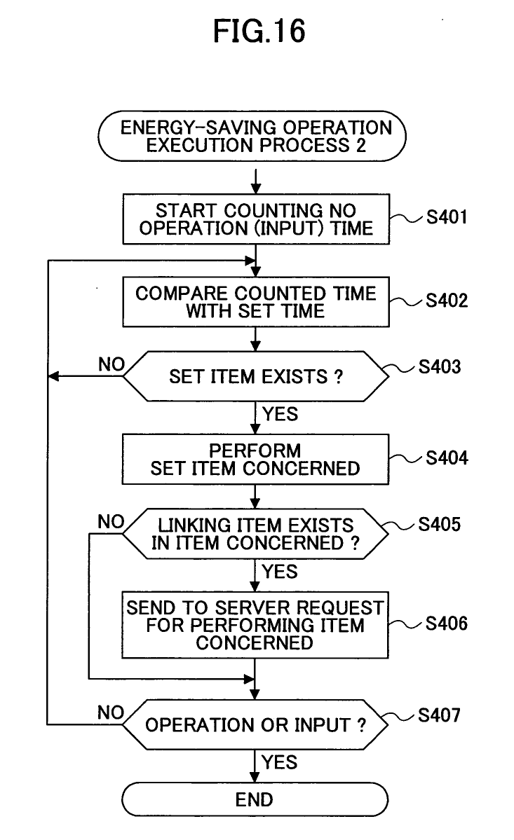

A description will be given, with reference to a flowchart of FIG. 16, of an energy-saving operation execution process 2 for the server 200 to perform the above-mentioned energy-saving operation. The energy-saving operation execution process 2 is started each time the operation and input to the server 200 is completed.

That is, each time the operation to the server 200 such as an operation to send print data through the LAN 10 is completed, the control unit 210 of the server 200 starts counting the time of no operation or no input (step S401). It should be noted that the control unit 210 has a predetermined timer circuit.

The control unit 210 continuously compares the set time of the MFP energy-saving operation defined in the energy-saving management data in the memory unit 216 with a count value of a passed time of the no operation or no input that was started in step S401 (step S402), and determines whether or not there is any item to which the set time equal to the passed time concerned is set (step S403). If there is no item to which a set time equal to the passed time (step S403: No), the control unit 210 continues the count of the no operation or no input time. On the other hand, If there is an item to which a set time equal to the passed time (step S403: Yes), the control unit 210 controls the communication control unit 220, the input control unit 230, the output control unit 240, the program storing unit 250 and the memory unit 260 so as to perform the energy-saving operation corresponding to the item concerned (step S404). For example, if the item is the hard disk stop operation, the control unit 210 controls the program storing unit 250 and the memory unit 260 so as to stop a rotation of the hard disk. Thus, when a predetermined energy-saving operation is performed as mentioned above, the state of the server 200 shifts from an in-operation state to a standby state.

The control unit 210 refers to the energy-saving management data in the memory unit 260 so as to determine whether or not the MFP energy-saving operation linking with the energy-saving operation performed in step S404 is set (step S405). Here, if there is no linking item (step S405: No), the process of steps S401-S405 is repeated until there are operation or input to the server 200 (step S407: No). That is, the count of the no operation or no input time is continued so as to perform the energy-saving operation corresponding to passed time.

On the other hand, if there is an item in which the linking item is set (step S405: Yes), the control unit 210 sends information which requests execution of the energy-saving operation to the MFP 100 through the LAN 100 (step S406). Here, for example, the information indicating the server energy-saving operation performed in step S404 is sent to the MFP 100. Then, in the MFP 100, the control unit 110 performs the energy-saving operation in accordance with the received energy-saving operation information. That is, a predetermined energy-saving operation of the MFP 100 is performed by linking with the energy-saving operation of the server 200. The control unit 210 of the server 200 determines whether or not there is an operation or an input to the server 200 (step S407). If there is no operation or input (step S407: No), the process of steps S402-S406 is repeated.

On the other hand, when there is an operation or an input to the server 200 (step S407: Yes), the process is ended. That is, the server 200 returns to a predetermined in-operation state from the standby state.

As mentioned above, according to the operation according to the present embodiment, if an energy-saving operation is set in the server 200, a predetermined energy-saving operation is performed in the MFP 100 in association with the energy-saving operation of the server 200 when the energy-saving operation is performed in the server 200.

(Third Embodiment)

Although the energy-saving management data stored in the MFP 100 is updated using MFP 100 in the first embodiment and the energy-saving management data stored in the server 200 is updated using server 200 in the second embodiment, the energy-saving management data stored in the MFP 100 may be updated using the server 200. A description will be given below of an operation of the MFP system 1 in such as case. It should be noted that a structure of the MFP system 1 according to the present embodiment is the same as that of the above-mentioned embodiments.

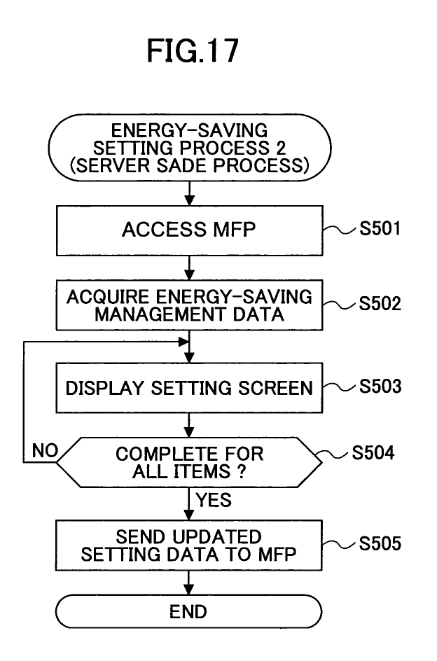

A description will be given, with reference to a flowchart of FIG. 17, of an operation (energy-saving setting process 3) of the server 200 when updating the energy-saving management data of the MFP 100 using the server 200. The energy-saving setting process 3 is started by a user instructing a start of the energy-saving setting by operating the operation panel 121 or the display 122 of the MFP 100.

When the process is started, the control unit 210 of the server 200 accesses the MFP 100 (step S501), and requests to the control unit 110 of the MFP 100 to send the energy-saving management data in the flash memory 116. In response to the request of the server 200, the control unit 110 of the MFP 100 acquires the energy-saving management data from the flash memory 116 and sends the data to the server 200. The server 200 receives the energy-saving management data from the MFP 100 (step S502), and displays a predetermined screen as shown in FIG. 15 on the display 122 of the MFP 100 in accordance with the acquired energy-saving management data (step S503).

The user operates the operation panel 121 so as to set the energy-saving operations of the MFP 100 and the server 200 through the setting screen and also a linking relationship therebetween. When the end button is selected after completion of the setting for all items (step S504: Yes), the control unit 210 sends the updated setting data to the MFP 100 (step S505), and the process is ended. Then, the MFP 100 performs the energy-saving operation execution process shown in FIG. 12 so that the energy-saving operation of the MFP 100 and the energy-saving operation of the server 200 are performed.

According to the above-mentioned operation of the present embodiment, the energy-saving operation of the MFP 100 and the energy-saving operation of the server 200 to be linked with the energy-saving operation of the MFP 100 can be set on the server 200.

(Fourth Embodiment)

Although the energy-saving management data stored in the MFP 100 is updated by the server 200 in the above-mentioned third embodiment, the data may be undated using the internal client terminal 300 connected to the LAN 10. A description will be given below of an operation of the MFP system 1.

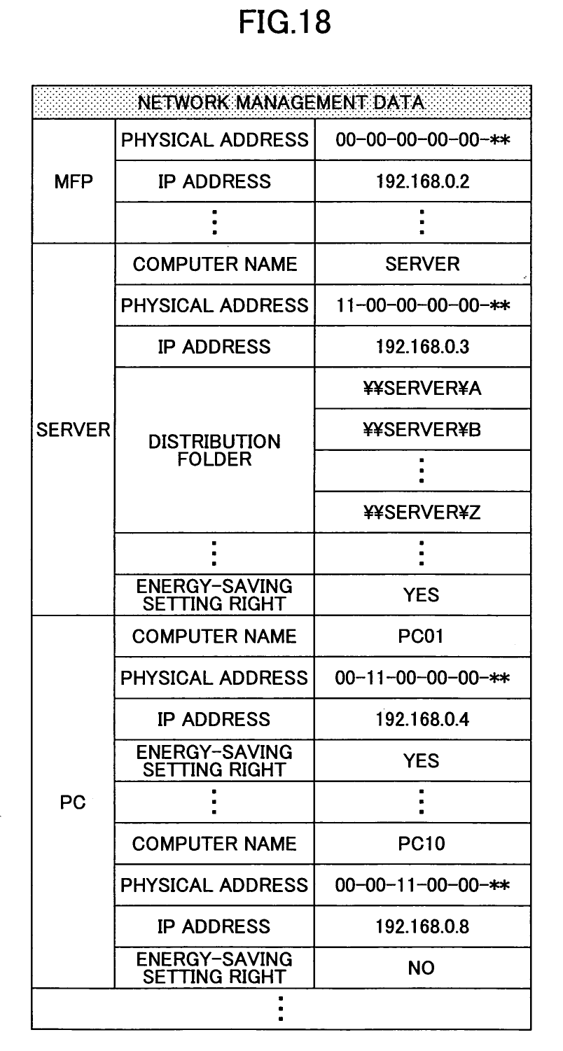

When updating the energy-saving management data using the internal client terminal 300, as shown in FIG. 18, information regarding the internal client terminal 300 (PC) is contained beforehand in the network management data of the MFP 100. It should be noted that the information regarding the internal client terminal 300 includes, in addition to the network address information, information regarding whether or not the internal client terminal 300 has a right to set (update) the energy-saving management data.

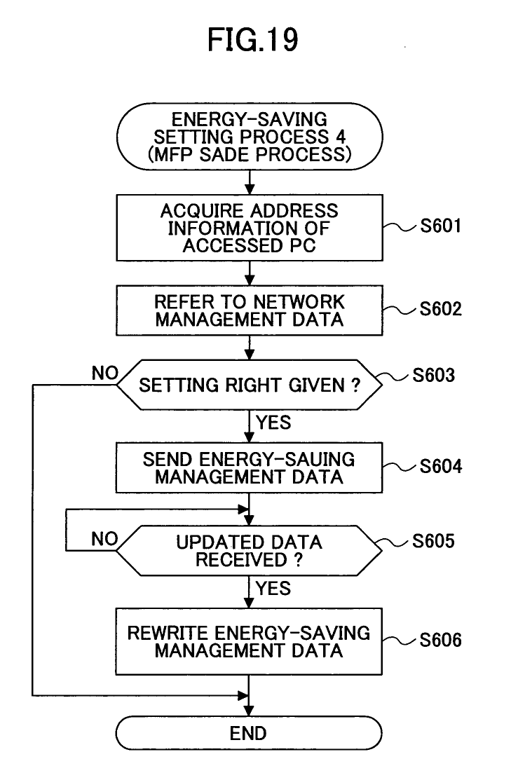

A description will now be given, with reference to a flowchart of FIG. 19, of an operation (energy-saving setting process 4) of the MFP 100 when setting (updating) the energy-saving management data using such network management data. The energy-saving setting process 4 is started by the internal client terminal 300 accessing the MFP 100 through the LAN 10.

First, the control unit 100 of the MFP 100 acquires the address information (MAC address, IP address, etc.) of the internal client terminal 300 (step S601). Next, the control unit 110 refers to the network management data stored in the flash memory 116 (step S602) so as to check existence of the energy-saving setting right related to the address in formation acquired in step S601 (step S603). Here, when the energy-saving setting right is not included in the address information concerned (step S603: No), the control unit 110 returns a predetermined error message or the like to the internal client terminal 300 concerned, and the process is ended.

On the other hand, when energy-saving setting authority is given to the address information concerned (step S603: Yes), the control section 110 acquires the energy-saving management data from the flash memory 116 and sends the acquired data to the internal client terminal 300 concerned (step S604). That is, the control unit 110 authenticates the client terminal which accessed the MFP 100, and provides the energy-saving management data to the client terminal which satisfies predetermined conditions.

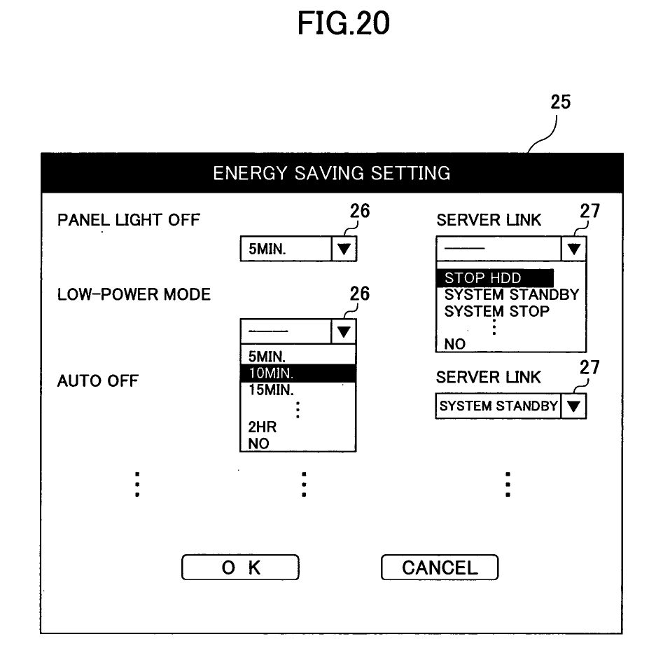

In the internal client terminal 300 concerned, an energy-saving setting screen 25 as shown in FIG. 20 is displayed. As shown in FIG. 20, corresponding to the MFP side energy-saving operation items, for example, an energy-saving item setting means 26 such as a pull-down menu is displayed on the energy-saving setting screen 25, and also a set time or nonexecution is selectably displayed for each item. The user operates a predetermined input device (keyboard, pointing device, etc.) so as to select and input the nonexecution (No) or a desired set time for each item. Moreover, corresponding to each item, a linking item setting means 27 for specifying the detail of the server linkage, such as a pull down menu, is displayed. Here, the energy-saving operation of the server 200 which is to be performed in linkage with the energy-saving operation of the MFP 100 set by the energy-saving setting means 26 or nonexecution of the linkage is selectably displayed. By performing the same process as the process of steps S503-S505 shown in FIG. 17, the internal client terminal 300 updates the energy-saving setting, and sends the setting information it to the MFP 100.

Upon receipt of the updated energy-saving setting data from the internal client terminal 300 concerned (step S605: Yes), the MFP 100 rewrites the energy-saving management data in the flash memory 116 with the contents of the updated data (step S606), and the process is ended. After the update of the energy-saving management data in the MFP 100, the energy-saving operation of the MFP 100 is performed by the energy-saving operation execution process as shown in FIG. 12, and the energy-saving operation of the server 200 links with the energy-saving operation of the MFP 100.

According to the operation of the present embodiment, the energy-saving management data of the MFP 100 can be set (updated) using the internal client terminals 300 such as a personal computer, the setting and change can be made easily. Moreover, the energy-saving management data can be accessed through the internal client terminal 300.

(Fifth Embodiment)

Although the energy-saving management data is updated by accessing the MFP 100 directly from the internal client terminal 300 in the above-mentioned fourth embodiment, there may be a case in which the external client terminal 400 cannot access the MFP 100 directly with such a structure. Thus, the server 200 may serve as an intermediator. In such as case, information the same as the network management data shown in FIG. 18 is stored in the memory unit 260 of the server 200.

A description will now be given below of an operation of the MFP system 1 having the above-mentioned structure. It should be noted that, in the present embodiment, hereafter, the internal client terminal 300 and the external client terminal 400 together may be refereed to as a client terminal. That is, the client terminal in the following description indicates either the internal client terminal 300 or the external client terminal 400.

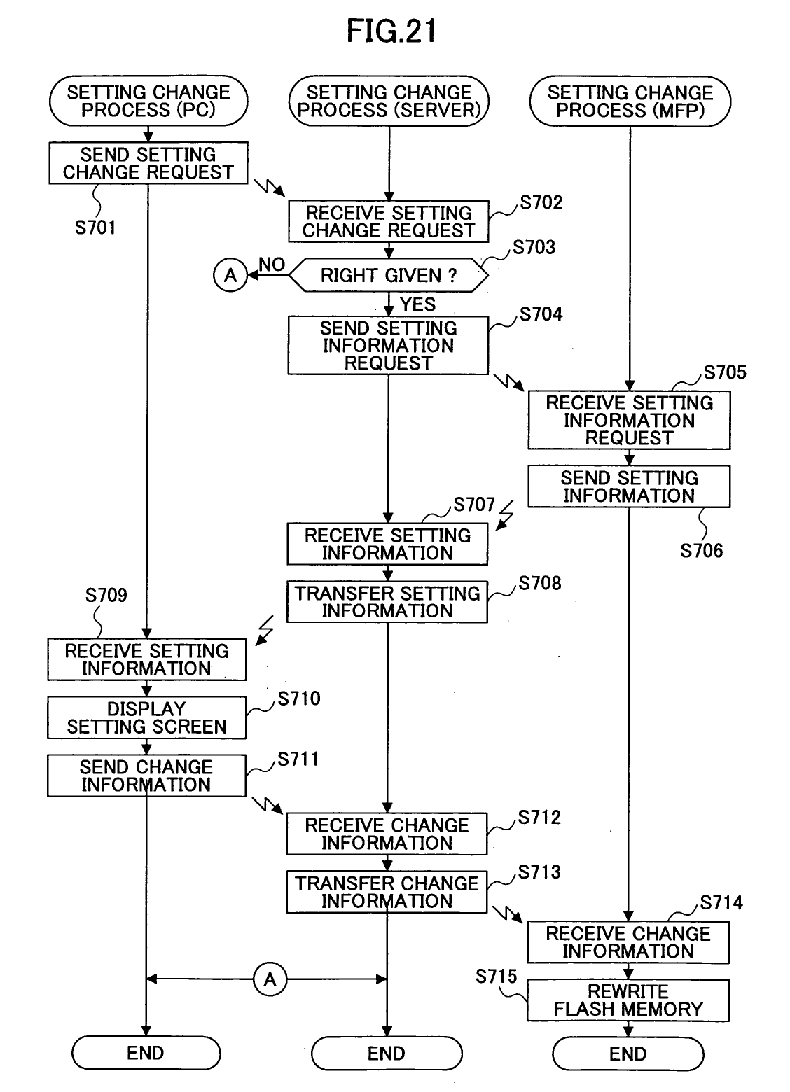

A description will now be given, with reference to a flowchart of FIG. 21, of an operation (setting change process) of the client terminal, the server 200 and the MFP 100.

First, the client terminal sends information (hereinafter, referred to as update request information) for requesting an update of the energy-saving management data of the MFP 100 to the server 200 through the LAN 10 or the WAN 20 (step S701). Upon receipt of the update request information from the client terminal (step S702), the control unit 210 of the server 200 acquires address information of the client terminal concerned and determines whether there is an energy-saving setting right corresponding to the address information by referring to the network management data in the memory unit 260 (step S703).

Here, if it is determined that there is no right (step S703: No), the control unit 210 of the server 200 returns, for example, a predetermined error message to the client terminal concerned, and the process is ended. On the other hand, if the client terminal has an energy-saving setting right (step S703: Yes), the control unit 210 of the server 200 sends to the MPF 100 information (hereinafter, referred to as a setting information request) for requesting the energy-saving management data of the MFP 100 (step S704).

When the MFP 100 receives the setting information request from the server 200 (step S705), the control unit 110 acquires energy-saving management data from the flash memory 116. The acquired energy-saving management data (referred to as setting information in the figure) is sent to the server 200 (step S706). Upon reception of the energy-saving management data (step S707), the server 200 transmits the energy-saving management data to the requesting client terminal through the LAN 10 under a control of the control unit 210 (step S708). Upon reception of the energy-saving management data by the requesting client terminal (step S709), an energy-saving setting screen 25 as shown in FIG. 20 is displayed in accordance with the received energy-saving management data (step S710). Thus, a user sets or changes an energy-saving operation of the MFP 100 and the energy-saving operation of the server 200 to be linked with the energy-saving operation of the MFP 100 through the displayed energy-saving setting screen 25.

Then, according to selection of an “OK” button, etc., the changed setting information (referred to as change information in the figure) is sent to the server 200 through the LAN 10 (step S711). When the communication control unit 220 of the server 200 receives the change information (step S712), the change information is transferred to the MFP 100 by the control unit 210 (step S713). Upon reception of the change information by the MFP 100 (step S714), the control unit 110 rewrites the energy-saving management data in the flash memory 116 in accordance with the received change information (step S715), and the process is ended.

Thus, when the MFP 100 performs the energy-saving operation execution process shown in FIG. 12 in accordance with the thus-set energy saving management data, the energy-saving operation of MFP 100 is performed and the energy-saving operation of the server 200 linking with the energy-saving operation of MFP 100 is also performed.

According to the structure of the above-mentioned embodiment, since the server 200 has network information regarding the client terminal, there is no need to store such information in the MFP 100. Moreover, only the server 200 is able to perform communication regarding the update of the energy-saving management data. Thus, the server may apply an appropriate filtering process, and the MFP 100 may perform communication with only the server 200, which achieves the setting change from the client terminal without decreasing the operation efficiency of the client terminal. Moreover, since the filtering process is applied, the setting or change of the energy-saving operation can be performed using not only the internal client terminal 300 connected to the LAN 10 but also the external client terminal 400. That is, a management person or the like can update or refer to the energy-saving management data at outside using a cellular phone or the like, which is very convenient.

It should be noted that although the case where the energy-saving management data stored in the MFP 100 is updated using the client terminal in the above-mentioned fifth embodiment, the server 200 may store the energy-saving management data as is in the second embodiment.

Although a ROM is used as a memory medium for storing the programs in the MFP 100 and the flash memory is used as a memory medium for storing various kinds of data in the above-mentioned embodiments, a type of the storing medium is no limited to the specifically described memory and an arbitrary memory may used. For example, the programs and data may be stored in the memory unit 170.

Additionally, although the gateway apparatus 30 is interposed between the WAN 20 and the LAN 10 in the above-mentioned embodiments, for example, the server 200 may have the function of the gateway apparatus 30. In such as case, the server 200 serves as a so-called application gateway so as to achieve a router function or a firewall function.

Further, although the server 200 is integrally mounted to the MFP 100 in the above-mentioned embodiments, for example, the MFP 100 and the server 200 may be separate apparatuses.

Moreover, although the structure using the multi-function printer (MFP) having the printer function, the facsimile function, the copy function, and the scanner function in the above-mentioned embodiments, for example, a single function printer or a scanner ma be used.

It should be noted that the server according to the above-mentioned embodiments may be achieved as an exclusive apparatus, and also achieved using an ordinary computer system. For example, the server 200 may be constituted to perform the above-mentioned process by acquiring programs for executing the above-mentioned process from a medium (CD-ROM, etc) that stores the programs for executing the above-mentioned process.

Moreover, the means for supplying a program to the computer can be arbitrarily selected. For example, the program may be supplied through a communication circuit, a communication network, a communication system, etc. As one example, the program concerned is exhibited on the bulletin board, and the program is distributed through the network by superimposing on a carrier wave. Then, the program is executed under a control of an operation system similar to other application programs, which can achieve the above-mentioned process.

As mentioned above, according to the present invention, in the MFP system in which the MFP and the server cooperate with each other, an environmental load during use can be effectively reduced, and a work load to a user is reduced.

The present invention is not limited to the specifically disclosed embodiments, and variations and modifications may be made without departing from the scope of the present invention.

The present application is based on Japanese priority application No. 2003-287217 filed Aug. 5, 2003, the entire contents of which are hereby incorporated by reference.

1. A multi-function printer system comprising at least one multi-function printer equipped with a server and at least one client terminal connected with each other through a communication network, said multi-function printer system comprising:
means for setting energy-saving operations of said multi-function printer and said server; means for relating the energy-saving operation of said multi-function printer and the energy-saving operation of said server to each other;
means for performing the energy-saving operation of said multi-function printer in accordance with said setting; and
means for performing the energy-saving operation of said server in linkage with the energy-saving operation of said multi-function printer.

2. The multi-function printer system as claimed in claim 1, further comprising:
means for performing the energy-saving operation of said server in accordance with said setting; and
means for performing the energy-saving operation of said multi-function printer in linkage with the energy-saving operation performed.

3. The multi-function printer system as claimed in claim 1, wherein said means for setting the energy-saving operations sets the energy-saving through said communication network in accordance with an input from said client terminal.

4. The multi-function printer system as claimed in claim 1, wherein said means for setting the energy-saving operations performs an encryption when performing communication with said client terminal.

5. The multi-function printer system as claimed in claim 1, wherein said means for setting the energy-saving operations performs an authentication on said client terminal and performs said setting in accordance with an input from said client terminal.

6. A multi-function printer equipped with a server, comprising:
an energy-saving operation setting unit that performs setting of an energy-saving operation of said multi-function printer; and
an energy-saving operation performing unit that performs the energy-saving operation set by said energy-saving operation setting unit,
wherein said energy-saving operation setting unit sets an energy-saving operation of said server that is performed in linkage with the energy-saving operation of said multi-function printer; and
said energy-saving operation performing unit cause said server to perform the energy-saving operation of said server in linkage with execution of the energy-saving operation of said multi-function printer.

7. The multi-function printer as claimed in claim 6, wherein said energy-saving operation setting unit sets the energy-saving operations in accordance with an input received from a client terminal connected through a communication network.

8. A server adapted to be mounted to a multi-function printer, comprising:
energy-saving operation setting means for setting an energy-saving operation set to said multi-function printer and setting information of an energy-saving operation of said server by relating to each other; and
energy-saving operation performing means for performing the energy-saving operation of said server in linkage with an execution of the energy-saving operation of said multi-function printer.

9. The server as claimed in claim 8, wherein said energy-saving operation setting means sets the energy-saving operation of said server in accordance with an input from a client terminal connected through a communication network.

10. An environmental load reducing method of a multi-function printer system in which at least one multi-function printer equipped with a server and at least one client terminal are connected through a communication network, the method comprising the steps of:
setting an energy-saving operation performed in said multi-function printer and an energy-saving operation performed in said server from said client terminal through said communication network; and
performing the energy-saving operations while said multi-function printer and said server are linked with each other in accordance with the setting,
wherein an environmental load during use of said multi-function printer system is reduced by performing the energy-saving operations in linkage with each other.

11. A program causing a computer to function as a server adapted to be mounted to a multi-function printer, comprising:
energy-saving operation setting means for setting an energy-saving operation set to said multi-function printer and setting information of an energy-saving operation of said server by relating to each other; and
energy-saving operation performing means for performing the energy-saving operation of said server in linkage with an execution of the energy-saving operation of said multi-function printer.

12. The program as claimed in claim 11, wherein said energy-saving operation setting means sets the energy-saving operation of said server in accordance with an input from a client terminal connected through a communication network.

13. A program for causing a computer to perform an environmental load reducing method of a multi-function printer system in which at least one multi-function printer equipped with a server and at least one client terminal are connected through a communication network, the method comprising the steps of:
setting an energy-saving operation performed in said multi-function printer and an energy-saving operation performed in said server from said client terminal through said communication network; and
performing the energy-saving operations while said multi-function printer and said server are linked with each other in accordance with the setting,
wherein an environmental load during use of said multi-function printer system is reduced by performing the energy-saving operations in linkage with each other.
